(19) United States
(12) Patent Application Publication
(10) Pub. No.: US 2013/0276443 A1
(43) Pub. Date: Oct. 24, 2013

(54) SYSTEM AND METHOD FOR CONTROLLING AN EXHAUST-BRAKING ENGINE MANEUVER

(71) Applicants: Steven J. Andrasko, Oshkosh, WI (US); Yun Xiao, Ann Arbor, MI (US); Michael C. Ross, New Boston, MI (US); Chad E. Marlett, Plymouth, MI (US)

(72) Inventors: Steven J. Andrasko, Oshkosh, WI (US); Yun Xiao, Ann Arbor, MI (US); Michael C. Ross, New Boston, MI (US); Chad E. Marlett, Plymouth, MI (US)

(73) Assignee: GM GLOBAL TECHNOLOGY OPERATIONS LLC, Detroit, MI (US)

(21) Appl. No.: 13/450,827

(22) Filed: Apr. 19, 2012

(51) Int. Cl. F02D 23/00; F02D 9/06

(52) U.S. Cl. 60/602

(57) ABSTRACT

A method for controlling an exhaust-braking engine maneuver includes driving a compressor by a turbine so that the compressor receives and compresses an intake stream of fluid to produce a stream of compressed fluid. The method also includes receiving a stream of engine working fluid that includes the stream of compressed fluid, and discharging, to an exhaust system, an exhaust stream comprising the stream of engine working fluid. A stream of scavenged exhaust fluid comprising at least a portion of the exhaust stream is received, and work is extracted from the stream of scavenged exhaust fluid by the turbine to drive the compressor. The variable turbine nozzle and an intake throttle valve are modulated so as to satisfy one or more turbine control criterion and one or more compressor control criterion.

### FIELD OF THE INVENTION

The subject invention relates to vehicle exhaust brakes and more particularly to a system and method for controlling vehicle exhaust-braking engine maneuvers involving modulation of a variable turbine nozzle and an intake throttle valve.

### BACKGROUND

Exhaust brakes are commonly used to aid in vehicle braking. Typically, exhaust braking is accomplished by decreasing or terminating the flow of fuel to the engine while obstructing the exhaust path from the vehicle's engine such that energy consumed pumping the working fluid (e.g., air) through the engine produces torque (i.e., braking torque) that opposes motion of the vehicle, thereby aiding in braking and decelerating the vehicle.

In order to increase braking torque for a particular engine, it is desirable to increase the difference between energy required to pump the working fluid through the engine and energy produced by the working fluid as it undergoes expansion in either the engine cylinders or in an associated turbocharger turbine. In general, this difference, or net energy demand, depends upon a number of factors including the extent to which the working fluid is compressed and expanded as it is pumped, the mass flow rate of the working fluid being pumped, and the thermodynamic efficiencies of the compression and expansion aspects of the pumping process.

In a turbocharged engine, the thermodynamic process followed by the working fluid involves induction through an engine intake system, compression in a compressor section of a turbocharger, further compression in one or more engine compression chambers (e.g., cylinders), expansion in the one or more chambers, further expansion in a turbine section of the turbocharger, and discharge in an exhaust section associated with the engine. Input of work energy is required in compression portions of the thermodynamic process, and work energy is produced during expansion portions of the thermodynamic process. A difference between work input required for compression and work output produced via expansion is generally realized as output torque at the engine flywheel.

In designing a turbocharged engine, the operating characteristics of the compressor and turbine of the turbocharger are typically matched so that their thermodynamic efficiencies are at relatively high levels during normal operation of the engine. Accordingly, the components are selected or designed so that, as an engine is throttled during normal operation between idle and maximum speeds, the relationship between compression ratio and mass flow rate of the compressor corresponds to regions of component operating maps where thermodynamic efficiency is maintained at desirable levels (e.g., at approximately maximized levels). For example, it is desirable to select or design components wherein typical engine operation corresponds to operation of the turbo-machinery components in the vicinity of one or more efficiency islands or peaks. Thus, a component operating line may traverse a series of efficiency islands and/or peaks. Accordingly, a properly selected or designed turbocharger compressor operates “on-design” during normal operation of the host engine. Similarly, the relationship between pressure ratio and mass flow rate of the turbine is such that its thermodynamic efficiency is also maintained at desired levels (e.g., at approximately maximized levels). Thus, a properly matched turbocharger turbine also operates “on-design” during normal operation of the host engine.

In some turbocharger arrangements, a variable area turbine inlet nozzle, which may comprise an assembly of adjustable vanes or vane segments, enables control over the pressure of the working fluid as it enters the turbine. In addition, a variable obstruction may exist in the engine exhaust system, facilitating control over the imposition of back-pressure to the engine. Accordingly, adjustments can be made between the extent to which the working fluid may expand (thereby producing work) in the one or more engine cylinders as well as the extent to which the working fluid may expand (thereby producing work) in the turbocharger turbine.

Unfortunately, such controls are typically configured solely so as to enhance engine efficiency by causing the turbine and/or the compressor to operate on-design, at or near their levels of peak thermodynamic efficiency. While such on-design operation may be beneficial during normal operation of the engine, it can be more preferable to be able to de-tune the operation of these components during some maneuvers, such as exhaust braking, so that the components operate at relatively lower levels of thermodynamic efficiency, such as at off-design operating conditions.

Accordingly, it is desirable to have an improved system and method for controlling operation of a turbocharged engine during exhaust braking engine maneuvers.

### SUMMARY OF THE INVENTION

In one exemplary embodiment of the invention, a method for controlling an exhaust-braking engine maneuver includes driving a compressor by a turbine so that the compressor receives and compresses a compressor intake stream of fluid to produce a stream of compressed fluid. The method also includes receiving, by an internal combustion engine, a stream of engine working fluid that includes the stream of compressed fluid, and discharging, by the internal combustion engine and to an exhaust system, an exhaust stream comprising the stream of engine working fluid. A stream of scavenged exhaust fluid comprising at least a portion of the exhaust stream is received through a variable turbine nozzle, and work is extracted, in the turbine, from the stream of scavenged exhaust fluid to drive the compressor. The variable turbine nozzle and an intake throttle valve are modulated so as to satisfy one or more turbine control criterion and one or more compressor control criterion.

In another exemplary embodiment of the invention, a system for controlling vehicle exhaust-braking engine maneuvers includes a compressor driven by a turbine and configured for receiving a compressor intake stream of fluid. The compressor is configured for compressing the compressor intake stream of fluid to produce a stream of compressed fluid. The system also includes an intake throttle valve positioned and configured for modulating a mass flow rate of the compressor intake stream of fluid and an internal combustion engine for receiving a stream of engine working fluid comprising the stream of compressed fluid. The internal combustion engine includes at least one cylinder for compressing and expanding the stream of engine working fluid before discharging an exhaust stream comprising the stream of engine working fluid to an exhaust system. The turbine is positioned in the exhaust system for receiving, through a variable turbine nozzle, a stream of scavenged exhaust fluid comprising at least a portion of the stream of engine working fluid. The turbine is configured for extracting work from the stream of scavenged exhaust fluid to drive the compressor. The variable turbine nozzle is configured to be modulated, and the intake throttle valve is configured to be modulated, so as to satisfy one or more turbine control criterion and one or more compressor control criterion.

The above features and advantages and other features and advantages of the invention are readily apparent from the following detailed description of the invention when taken in connection with the accompanying drawings.

### BRIEF DESCRIPTION OF THE DRAWINGS

Other features, advantages and details appear, by way of example only, in the following detailed description of embodiments, the detailed description referring to the drawings in which:

FIG. 1 is a schematic drawing showing an exemplary system for controlling vehicle exhaust-braking engine maneuvers; and

FIG. 2 is a flow chart showing an exemplary method for controlling vehicle exhaust-braking engine maneuvers.

### DETAILED DESCRIPTION OF THE DRAWINGS

The following description is merely exemplary in nature and is not intended to limit the present disclosure, its application or uses. It should be understood that throughout the drawings, corresponding reference numerals indicate like or corresponding parts and features.

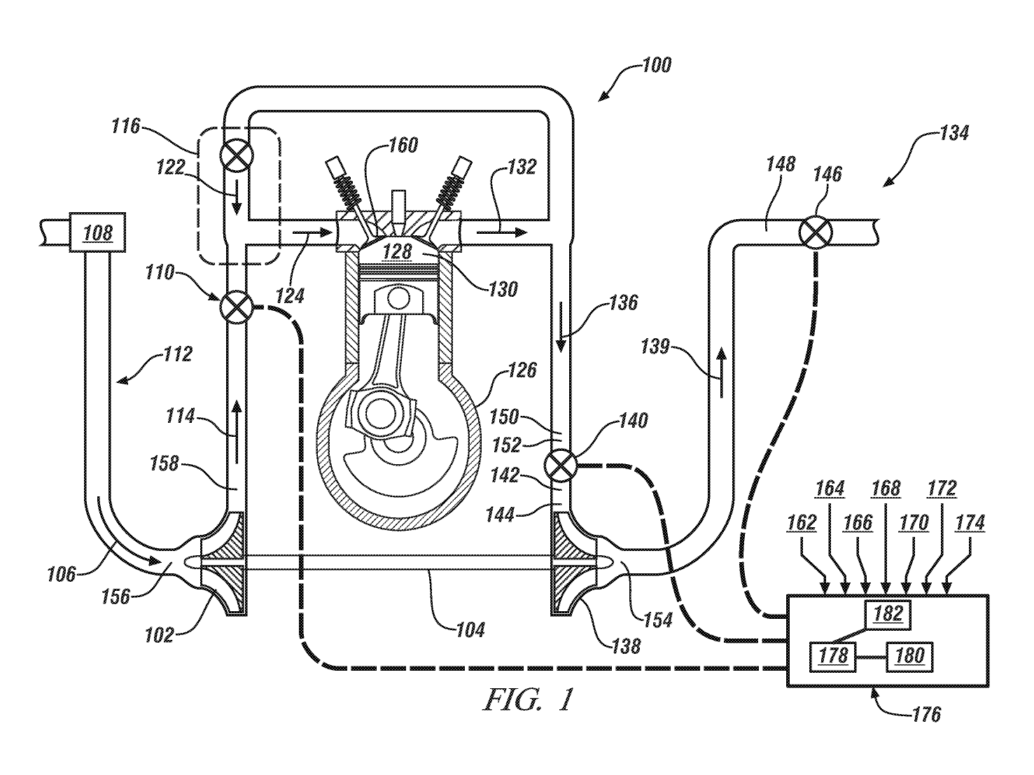

In accordance with an exemplary embodiment of the invention, FIG. 1 shows an exemplary system 100 for controlling vehicle exhaust-braking engine maneuvers. As shown in FIG. 1, the system 100 includes a compressor 102 driven by a turbine 138 via a turbocharger shaft 104. The compressor 102 receives a compressor intake stream of fluid 106 from an intake filter 108. An intake throttle valve 110 is positioned and configured for modulating a mass flow rate of the intake stream of fluid 106 so as to satisfy one or more compressor or turbine control criterion. For example, a compressor control criterion may be configured so as to result in an increase in braking torque or other reduction in engine work output. In an exemplary embodiment, the intake throttle valve 110 is positioned in the flow path 112 between the intake filter 108 and the compressor 102. As one skilled in the art will appreciate, the intake throttle valve 110 may be any valve suitable for modulating the mass flow rate of the intake stream of fluid 106, such as a butterfly valve suitable for immersion in the intake stream of fluid. The compressor 102 is configured for compressing the compressor intake stream of fluid 106 to produce a stream of compressed fluid 114.

In an exemplary embodiment, the compressor 102 provides the stream of compressed fluid 114 to an intake mixing section 116, which is configured for combining the stream of compressed fluid 114 with a stream of recirculated engine working fluid 122 to produce a mixed intake stream 124. While the extent to which the mixed input stream 124 includes mass flow contributed from the stream of recirculated engine working fluid 122 may vary, the mixed intake stream 124 nonetheless comprises the stream of compressed fluid 114.

An internal combustion engine 126 receives the mixed intake stream 124 and, if applicable, combines the mixed intake stream 124 with fuel to form a stream of engine working fluid 128. The internal combustion engine 126 includes at least one chamber 130 (e.g., cylinder) for compressing and expanding the stream of engine working fluid 128 before discharging an exhaust stream 132 that comprises at least a portion of the stream of combusted engine working fluid 128 to an exhaust system 134. In an exemplary embodiment, the internal combustion engine 126 is a compression-ignition engine, such as a diesel engine. The advantages disclosed herein, however, are equally applicable to other engine cycles and configurations such as two-stroke or four-stroke spark-ignition engines. In addition, while the advantages disclosed herein are described with reference to applications intended to improve deceleration of a vehicle in which the internal combustion engine 126 may be installed, one skilled in the art will appreciate that these advantages could easily be applied wherever it may be desirable to generate torque opposing output of power from the internal combustion engine 126. For example, the principals described herein may be useful in stationary installations such as power generating application, and it may be useful to produce the described enhanced negative torque to improve transient response (e.g., faster engine deceleration) of an engine in any installation.

Upon its discharge, at least a portion of the exhaust stream 132 is scavenged to form a stream of scavenged exhaust fluid 136. A turbine 138 is positioned for receiving, through a variable turbine nozzle 140, the stream of scavenged exhaust fluid 136, and the turbine 138 is configured for extracting work from the stream of scavenged exhaust fluid 136 to drive the compressor 102 via the turbocharger shaft 104. The variable turbine nozzle 140 is configured to be modulated so as to satisfy one or more compressor or turbine control criterion. An exemplary compressor or turbine control criterion may be configured so as to produce an elevated turbine inlet pressure and/or exhaust manifold pressure to produce a larger magnitude of negative work during the engine discharging process. Other exemplary criterion may be configured so as to decrease the turbine work available for driving the compressor. For example, such criterion may be devised so as to cause the turbine to operate at a point of relatively low efficiency. In an exemplary embodiment, the turbine 138 is configured as a radial-flow turbine, and the variable turbine nozzle 140 comprises a series of coupled vane segments 142 arranged about an inlet 144 of the turbine 138.

In an exemplary embodiment, an exhaust stream restrictor 146 may be arranged and configured for restricting passage of an expanded exhaust stream 139 through the exhaust system 134. In such embodiments, the exhaust stream restrictor 146 may be configured to be modulated so as to restrict passage of the expanded exhaust stream 139 through the exhaust system 134 during exhaust-braking engine maneuvers. An exhaust pressure sensing instrument 148 (or, as discussed below, a pressure modeling/estimating system) is configured for sensing (or, as discussed below, estimating) a pressure of the expanded exhaust stream 139. The pressure sensing instrument 148 is positioned in the expanded exhaust stream 139 upstream from the exhaust stream restrictor 146. As with other pressure sensing instruments described herein, the exhaust pressure sensing instrument 148 may be arranged so as to detect or deduce a static pressure or a total pressure as desired or required for a particular control and/or engine configuration. The exhaust stream restrictor 146 is configured to be modulated so as to satisfy one or more control criterion based on, for example, the pressure of the expanded exhaust stream 139 at a position in the exhaust system 134 upstream from the exhaust stream restrictor 146. As one skilled in the art will appreciate, the exhaust stream restrictor 146 may comprise a valve such as a butterfly valve suitable for immersion in the expanded exhaust stream 139. As one skilled in the art will appreciate, it may be necessary or desirable in some exemplary embodiments to rely upon model-estimated or predicted or deduced values for some parameters such as exhaust pressures and temperatures. Where appropriate such model-predicted/estimated/deduced values may be employed in place of, or in addition to, feedback provided by instrumentation described herein.

In an exemplary embodiment, a turbine inlet pressure sensing instrument 150 (or, as discussed above, a pressure modeling/estimating system) is configured for sensing (or, as discussed above, estimating) a pressure of the stream of scavenged exhaust fluid 136 in the vicinity of the variable turbine nozzle 140. In an exemplary embodiment, the turbine inlet pressure sensing instrument 150 is positioned in the stream of scavenged exhaust fluid 136 upstream from the variable turbine nozzle 140, and a turbine control criterion is based on the pressure of the stream of scavenged exhaust fluid 136 at a position upstream from the variable turbine nozzle 140, such as the position of the turbine inlet pressure sensing instrument 150. In an exemplary embodiment, a turbine control criterion comprises a maximum limit for the pressure of the stream of scavenged exhaust fluid 136 at a position in the exhaust system proximate the variable turbine nozzle 140, such as the position of the turbine inlet pressure sensing instrument 150.

In an exemplary embodiment, a turbine inlet temperature sensing instrument 152 (or, as discussed above, a temperature modeling/estimating system) is configured for sensing (or estimating) a temperature of the stream of scavenged exhaust fluid 136 upstream from the turbine 138. The turbine inlet temperature sensing instrument 152 is positioned in the exhaust system 134 upstream from the turbine 138. As with other temperature sensing instruments described herein, the turbine inlet temperature sensing instrument 152 may be arranged so as to detect or deduce or predict a temperature as desired or required for a particular control and/or engine configuration. In an exemplary embodiment, a turbine control criterion is based on the temperature of the stream of scavenged exhaust fluid 136 at a position in the exhaust system upstream from the turbine 138, such as the position of the turbine inlet temperature sensing instrument 152.

In an exemplary embodiment, a turbine exit temperature sensing instrument 154 is configured for sensing a temperature of the stream of expanded exhaust fluid 139 downstream from the turbine 138. The turbine exit temperature sensing instrument 154 is positioned in the exhaust system downstream from the turbine 138 such as in the stream of expanded exhaust fluid 139. In an exemplary embodiment, a turbine control criterion is based on the temperature of the stream of scavenged exhaust fluid 136 at a position in the exhaust system 134 downstream from the turbine 138. In another exemplary embodiment, a turbine control criterion is based on the change in temperature in the stream of scavenged exhaust fluid 136 passing through the turbine 138.

In an exemplary embodiment, a compressor inlet pressure sensing instrument 156 (or pressure estimating/modeling system) is configured for sensing (or estimating) a pressure of the compressor intake stream of fluid 106. The compressor inlet pressure sensing instrument 156 is positioned upstream from the compressor 102. A compressor control criterion may be based on the pressure of the compressor intake stream of fluid 106 at a position upstream from the compressor 102.

In an exemplary embodiment, a compressor exit pressure sensing instrument 158 (or, as discussed above, a pressure modeling/estimating system) is configured for sensing (or estimating) a pressure of the stream of compressed fluid 114. In an exemplary embodiment, the compressor exit pressure sensing instrument 158 is positioned in the stream of compressed fluid 114 proximate the exit of the compressor 102. A compressor control criterion may be based on the pressure of the stream of compressed fluid 114.

In an exemplary embodiment, a pre-compression-stroke pressure sensing instrument 160 (or, as discussed above, a temperature modeling/estimating system) is configured for sensing a pressure of the stream of engine working fluid 128 at a position prior to its compression within the internal combustion engine 126. In an exemplary embodiment, the pre-compression-stroke pressure sensing instrument 160 is positioned in the internal combustion engine 126 so as to measure the pressure of the mixed intake stream 124. A compressor control criterion may be based on the pressure of the stream of engine working fluid 128 at a position prior to its compression within the internal combustion engine 126, such as in the mixed intake stream 124.

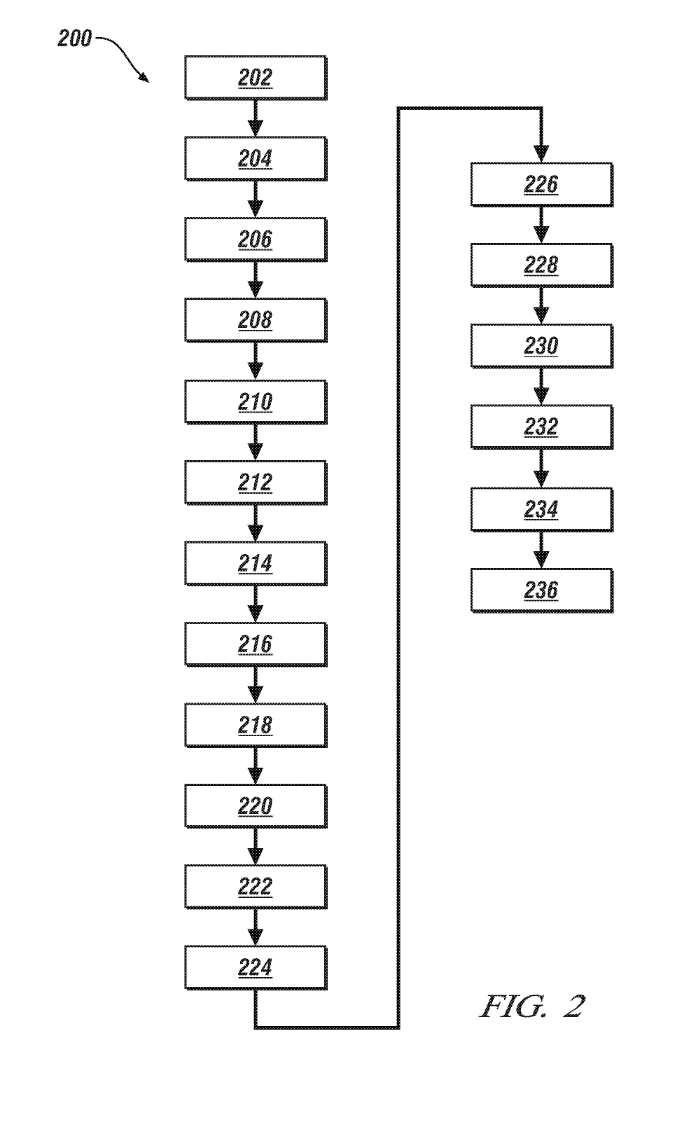

As shown in FIG. 2, a method 200 for controlling an exhaust-braking engine maneuver includes driving a compressor by a turbine via a turbocharger shaft (step 202) so that the compressor receives a compressor intake stream of fluid (step 204) and compresses the compressor intake stream of fluid to produce a stream of compressed fluid (step 206). The method 200 also includes positioning an intake throttle valve for modulating a mass flow rate or pressure of the compressor intake stream of fluid (step 208). An internal combustion engine receives a stream of engine working fluid comprising the stream of compressed fluid (step 210). The internal combustion engine includes at least one cylinder for compressing and expanding the stream of engine working fluid before discharging the stream of engine working fluid to an exhaust system (step 212).

The method 200 also includes positioning a turbine in the exhaust system for receiving, through a variable turbine nozzle, a scavenged turbine stream comprising at least a portion of the stream of engine working fluid (step 214). The turbine is configured for extracting work from the stream of working fluid to drive the compressor via the turbocharger shaft. In an exemplary embodiment, a method 200 for controlling vehicle exhaust-braking engine maneuvers includes modulating a position of the intake throttle valve (step 216) and modulating a position of the variable turbine nozzle (step 218) so as to satisfy one or more turbine control criterion and one or more compressor control criterion.

In an exemplary embodiment, a method 200 for controlling an exhaust-braking engine maneuver may optionally include providing an active exhaust stream restrictor arranged and configured for restricting passage of the stream of engine working fluid through the exhaust system and for modulating a flow of engine working fluid (step 220). In many embodiments, restrictions from exhaust system components are passive, however, in accordance with this step, those skilled in the art may choose to add a modulation capability in some embodiments. In such embodiments, a position of the active restrictor is modulated (step 222), for example, so as to achieve a desired level of engine back pressure or to satisfy one or more additional criteria.

In an exemplary embodiment, a method 200 for controlling an exhaust-braking engine maneuver includes sensing a pressure of the stream of engine working fluid at a position in the exhaust system upstream from the exhaust stream restrictor (step 224). In an exemplary embodiment, a control criterion may be based on the pressure of the stream of engine working fluid at a position in the exhaust system upstream from the exhaust stream restrictor.

In an exemplary embodiment, a method 200 for controlling an exhaust-braking engine maneuver includes sensing or otherwise determining a pressure of the stream of engine working fluid at a position in the exhaust system upstream from the variable turbine nozzle (step 226). Accordingly, a turbine control criterion or a compressor control criterion may be based on the pressure of the stream of engine working fluid at a position in the exhaust system upstream from the variable turbine nozzle. It should be appreciated that a turbine control criterion or a compressor control criterion may be based on a maximum limit for the pressure of the stream of engine working fluid at a position in the exhaust system upstream from the variable turbine nozzle. In some embodiments, it may be desirable to position the variable turbine nozzle so as to produce an elevated turbine inlet pressure while also causing the turbine to operate at a point of its operating envelope associated with a relatively low level of thermodynamic efficiency. Such a position may be associated, for example, with a relatively closed position of the variable turbine nozzle.

In an exemplary embodiment, a method 200 for controlling an exhaust-braking engine maneuver includes sensing a temperature of the stream of engine working fluid at a position in the exhaust system upstream from the turbine (step 228). Accordingly, a turbine control criterion or a compressor control criterion may be based on the temperature of the stream of engine working fluid at a position in the exhaust system upstream from the turbine.

In an exemplary embodiment, a method 200 for controlling an exhaust-braking engine maneuver includes sensing a temperature of the stream of engine working fluid at a position in the exhaust system downstream from the turbine (step 230). Accordingly, a turbine control criterion or a compressor control criterion may be based on the temperature of the stream of engine working fluid at a position in the exhaust system downstream from the turbine. In an exemplary embodiment, a turbine control criterion or a compressor control criterion may be based on measured or calculated or otherwise deduced work or energy extracted by the turbine. For example, one or more strain sensors may be used to deduce a torque produced by the turbine and applied to the turbocharger shaft, thereby enabling turbine work to be deduced or calculated.

In an exemplary embodiment, a method 200 for controlling an exhaust-braking engine maneuver includes sensing a pressure of the compressor intake stream of fluid at a position upstream from the compressor (step 232). Accordingly, a turbine control criterion or a compressor control criterion may be based on the pressure of the compressor intake stream of fluid at a position upstream from the compressor. For example, it may be desirable to modulate the intake throttle valve so as to achieve the desired airflow rate while also depressing the pressure of the compressor intake stream, thereby increasing the work required to drive the compressor and the braking power produced by the engine. A flow rate of the stream of engine working fluid may be determined (i.e., measured or calculated) at a position upstream from the compressor inlet. At least one of the turbine control criterion or the compressor control criterion may be based on a desired flow rate of the stream of engine working fluid.

In an exemplary embodiment, a method 200 for controlling an exhaust-braking engine maneuver includes sensing a pressure of the stream of compressed fluid (step 234). Accordingly, a turbine control criterion or a compressor control criterion may be based on the pressure of the stream of compressed fluid.

In an exemplary embodiment, a method 200 for controlling an exhaust-braking engine maneuver includes sensing a pressure of the stream of engine working fluid at a position prior to its compression within the internal combustion engine (step 236). Accordingly, a turbine control criterion or a compressor control criterion may be based on the pressure of the stream of engine working fluid at a position prior to its compression within the internal combustion engine.

By providing feedback from the instrumentation described herein (e.g., signals representing sensed operating parameters such as a pressure of the exhaust stream at a position in the exhaust system upstream from the exhaust stream restrictor 162, a pressure of the stream of scavenged exhaust fluid at a position in the exhaust system upstream from the variable turbine nozzle 164, a temperature of the stream of scavenged exhaust fluid at a position in the exhaust system upstream from the turbine 166, a temperature of the stream of scavenged exhaust fluid at a position in the exhaust system downstream from the turbine 168, a pressure of the compressor intake stream of fluid at a position upstream from the compressor 170, a pressure of the stream of compressed fluid 172, or a pressure of the stream of engine working fluid at a position prior to its compression within the internal combustion engine 174) to a controller 176, the controller 176 can cause an exhaust-braking engine maneuver to be performed in a more effective manner - even at extreme, off-design conditions such as at relatively cool or hot turbine inlet conditions, thusly providing for improved exhaust-braking effectiveness under a greater range of operating conditions. In an exemplary embodiment, a controller 176 comprises a microprocessor 178 that is coupled to a memory storage device 180 and configured so as to execute instructions 182 and thereby modulate the variable turbine nozzle 140 and/or, where available, the exhaust stream restrictor 146 and/or the intake throttle valve 110 so as to affect a mass flow rate of the stream of scavenged exhaust fluid 136 and/or a mass flow rate of the compressor intake stream 106 and/or a pressure in the exhaust stream 162, and thereby satisfy one or more turbine control criterion and/or one or more compressor control criterion and/or one or more exhaust pressure/back-pressure criterion implemented in instructions 182. For example, by modulating the intake throttle valve 110 while the variable turbine nozzle 140 is modulated to a relatively closed position, a system is enabled to more easily maintain turbine inlet pressure, which may be deduced from pressure 164, at a desired level.

Accordingly, the exemplary systems and methods disclosed herein provide an improved means for controlling operation of a turbocharged engine during exhaust-braking engine maneuvers. A coordinated exhaust brake control system and methodology facilitates control over operation of both the turbocharger compressor 102 and the turbocharger turbine 138 while modulating pressure in the exhaust system (i.e., back pressure) 162, thereby enabling improvements in braking performance (i.e., braking torque / power delivered to the engine flywheel) across a range of engine speeds. Such improvements in braking performance can be used to improve transient responses in the engine (e.g., engine deceleration) or the system in which the engine is installed (e.g., vehicle deceleration). By modulating the intake throttle valve 110 during exhaust braking maneuvers, operation of the turbine 138 and compressor 102 can be controlled so as to not only avoid incidental (and likely unintended) increases in thermodynamic efficiencies, but also to de-tune these turbo-machinery components, enabling them to be operated off-design (i.e., under operating conditions that result in relatively lower levels of thermodynamic efficiency). As a result, intake manifold pressure boost (related to the difference between pressure 170 and pressure 172) can be effectively reduced at a given level of turbine work, thereby increasing effectiveness of an exhaust-braking maneuver.

Exemplary systems and methods disclosed herein facilitate control over the intake throttle valve 110 to produce desirable mass flow rates of the engine working fluid 128. Intake throttle valve positions, corresponding intake stream mass flow rates, and/or compressor control criteria may be based on empirically determined relationships between intake throttle valve positions, intake stream mass flow rates, and sensed temperatures at the inlet or outlet of the turbocharger turbine. Accordingly, by modulating an intake throttle valve so as to affect turbine inlet pressure, intake manifold pressure supplied to the engine can be reduced, thereby increasing the quantity of power required to pump the engine working fluid without increasing the output of energy produced through expansion of the working fluid. As a result, more braking torque can be made available for deceleration of the engine and/or the device in which the engine is installed.

In an exemplary embodiment, the system 100 and method 200 facilitate monitoring feedback based on turbine inlet temperature 166 and/or turbine outlet temperature 168. These parameters may be used to characterize the mass or volume flow rate through the turbine 138 and thereby determine a rate of flow of the working fluid that provides a desired turbine inlet pressure 164, such as a maximum turbine inlet pressure with the variable turbine nozzle in a closed position. Such a rate of flow of the working fluid, determined so as to provide a desired turbine inlet pressure 164, can form the basis for an exemplary turbine control criterion. This working fluid flow rate can also be used as a compressor control criterion facilitating control over the intake throttle valve 110 and effectively maintaining turbine inlet pressure 164 at a desired level.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the application.

What is claimed is:

1. A method for controlling an exhaust-braking engine maneuver comprising:
driving a compressor using work extracted by a turbine so that the compressor receives and compresses a compressor intake stream of fluid to produce a stream of compressed fluid;
receiving, by an internal combustion engine, a stream of engine working fluid that includes the stream of compressed fluid,
discharging, by the internal combustion engine and to an exhaust system, an exhaust stream comprising the stream of engine working fluid;
receiving, through a variable turbine nozzle, a stream of scavenged exhaust fluid comprising at least a portion of the exhaust stream;
extracting, by the turbine, work from the stream of scavenged exhaust fluid to drive the compressor; and
modulating the variable turbine nozzle and an intake throttle valve so as to satisfy one or more turbine control criterion and one or more compressor control criterion.

2. The method of claim 1, wherein said one or more turbine control criterion is based on an elevated turbine inlet pressure.

3. The method of claim 1, wherein said one or more compressor control criterion is based on a depressed compressor inlet pressure.

4. The method of claim 1, further comprising determining a pressure of the stream of scavenged exhaust fluid at a position in the exhaust system upstream from the variable turbine nozzle, wherein at least one of said one or more turbine control criterion is based on the pressure of the stream of scavenged exhaust fluid at a position in the exhaust system upstream from the variable turbine nozzle.

5. The method of claim 4, wherein said at least one of said one or more turbine control criterion comprises a maximum limit for the pressure of the stream of scavenged exhaust fluid at a position in the exhaust system upstream from the variable turbine nozzle.

6. The method of claim 1, further comprising determining a temperature of the stream of scavenged exhaust fluid at a position in the exhaust system upstream from the turbine, wherein at least one of said one or more turbine control criterion is based on the temperature of the stream of scavenged exhaust fluid at a position in the exhaust system upstream from the turbine.

7. The method of claim 6, further comprising determining a temperature of the stream of scavenged exhaust fluid at a position in the exhaust system downstream from the turbine, wherein at least one of said one or more turbine control criterion is based on the temperature of the stream of scavenged exhaust fluid at a position in the exhaust system downstream from the turbine.

8. The method of claim 1, further comprising determining a pressure of the compressor intake stream of fluid at a position in the compressor, wherein at least one of said one or more compressor control criterion is based on the pressure of the compressor intake stream of fluid at a position in the compressor.

9. The method of claim 8, further comprising determining a pressure of the stream of compressed fluid, wherein at least one of said one or more compressor control criterion is based on the pressure of the stream of compressed fluid.

10. The method of claim 1, further comprising determining a pressure of the stream of engine working fluid at a position prior to its compression within the internal combustion engine, wherein at least one of said one or more compressor control criterion is based on the pressure of the stream of engine working fluid at a position prior to its compression within the internal combustion engine.

11. The method of claim 1, further comprising determining a flow rate of the stream of engine working fluid at a position upstream from the compressor inlet, wherein at least one of said turbine control criterion or said compressor control criterion is based on a desired flow rate of the stream of engine working fluid.

12. A system for controlling an exhaust-braking engine maneuver comprising:
a compressor that is driven by a turbine and configured for receiving and compressing a compressor intake stream of fluid to produce a stream of compressed fluid;
an intake throttle valve positioned and configured for modulating a mass flow rate of the compressor intake stream of fluid;
an internal combustion engine for receiving a stream of engine working fluid comprising the stream of compressed fluid, the internal combustion engine including at least one chamber for compressing and expanding the stream of engine working fluid before discharging an exhaust stream comprising the stream of engine working fluid to an exhaust system;
the turbine being positioned in the exhaust system for receiving, through a variable turbine nozzle, a stream of scavenged exhaust fluid comprising at least a portion of the exhaust stream, the turbine being configured for extracting work from the stream of scavenged exhaust fluid to drive the compressor;
the variable turbine nozzle being configured to be modulated, and the intake throttle valve being configured to be modulated, so as to satisfy one or more turbine control criterion and one or more compressor control criterion.

13. The system of claim 12, further comprising an instrument for sensing pressure of the exhaust stream at a position in the exhaust system downstream from the turbine.

14. The system of claim 12, further comprising an instrument for sensing a pressure of the stream of scavenged exhaust fluid at a position in the exhaust system upstream from the variable turbine nozzle, wherein at least one of said one or more turbine control criterion is based on the pressure of the stream of scavenged exhaust fluid at a position in the exhaust system upstream from the variable turbine nozzle.

15. The system of claim 14, wherein said at least one of said one or more turbine control criterion comprises a maximum limit for the pressure of the stream of scavenged exhaust fluid at a position in the exhaust system upstream from the variable turbine nozzle.

16. The system of claim 12, further comprising an instrument for sensing a temperature of the stream of scavenged exhaust fluid at a position in the exhaust system upstream from the turbine, wherein at least one of said one or more turbine control criterion is based on the temperature of the stream of scavenged exhaust fluid at a position in the exhaust system upstream from the turbine.

17. The system of claim 16, further comprising an instrument for sensing a temperature of the stream of scavenged exhaust fluid at a position in the exhaust system downstream from the turbine, wherein at least one of said one or more turbine control criterion is based on the temperature of the stream of scavenged exhaust fluid at a position in the exhaust system downstream from the turbine.

18. The system of claim 12, further comprising an instrument for sensing a pressure of the compressor intake stream of fluid at a position upstream from the compressor, wherein at least one of said one or more compressor control criterion is based on the pressure of the compressor intake stream of fluid at a position in the compressor.

19. The system of claim 18, further comprising an instrument for sensing a pressure of the stream of compressed fluid, wherein at least one of said one or more compressor control criterion is based on the pressure of the stream of compressed fluid.

20. The system of claim 12, further comprising an instrument for sensing a pressure of the stream of engine working fluid at a position prior to its compression within the internal combustion engine, wherein at least one of said one or more compressor control criterion is based on the pressure of the stream of engine working fluid at a position prior to its compression within the internal combustion engine, further comprising an instrument for sensing a flow rate of the stream of engine working fluid upstream from the compressor, wherein at least one of said one or more compressor control criterion is based on flow rate of the stream of engine working fluid upstream from the compressor.
